(19) United States
(12) Patent Application Publication
(10) Pub. No.: US 2003/0164591 A1
(43) Pub. Date: Sep. 4, 2003

(54) Apparatus and method for sealing a device in an opening

(76) Inventor: Viswanathan Subramanian, El Paso, TX (US)

Correspondence Address: MARGARET A. DOBROWITSKY, DELPHI TECHNOLOGIES, INC., Legal Staff, Mail Code: 480-414-420, P.O. Box 5052, Troy, MI, 48007-5052, US

(21) Appl. No.: 10/078,827

(22) Filed: Feb. 19, 2002

(51) Int. Cl. F16J 15/02

(52) U.S. Cl. 277/312

(57) ABSTRACT

A method and apparatus for converting a sensor designed for use in an open environment to a sensor for use in a closed environment where it is desirable to retain the fluids within the closed environment. The method comprises inserting an elongated portion of the sensor into a spacing member, the elongated portion has a first sensing means being configured to sense movement of a movable item in the closed environment; positioning an O-ring on the elongated portion adjacent to the spacer; and securing the location of the O-ring by placing a retaining member onto the elongated portion after the O-ring has been inserted thereon. The apparatus comprises: a spacing member; an O-ring; and a retaining ring.

### TECHNICAL FIELD

This application relates generally to a method and apparatus for sealing a device in an opening. In particular, this application relates to a method and apparatus for providing a sealing means for a device designed for use in an open environment.

### BACKGROUND

Sensor devices and the like are designed for numerous applications. For example, rotary position sensors are capable of determining the rotational position of a shaft or other member capable of moment about an axis. One example of such a sensing device is variable reluctance sensor capable of determining the angular position of a rotating wheel or shaft. These types of sensors have numerous applications in either a closed environment where the sensor is provided access through a bore hole or alternatively an open environment.

In the case of the former the closed environment may require that the internal area or environment be fluidly sealed from its exterior in order to retain the fluids therein. An example of this is a crank case of an internal combustion engine wherein the motor oil must remain in the interior compartment for obvious reasons. In this example, it may be desirous to monitor the rotary position of the crank shaft or other components in order to relay a signal back to an engine control module.

In order to monitor the rotary movement of the crank shaft a variable reluctance sensor is inserted into a bore hole in order to monitor the movement of the crank shaft. In order to maintain a good seal around the sensor inserted into the bore hole a sealing means is employed. For example, O-rings are capable of being positioned within a groove located on the outside diameter of the sensor. The groove is necessary in order to properly maintain the position of the O-ring in order to seal the sensor within the bore hole.

Other types of sealing means employ the use of a threaded sensor with or without an O-ring or a sealing adhesive or welding process, each of these methods are time consuming and may place unnecessary stresses upon the sensor device.

However, the same sensor or sensor design is applicable for use in an open environment application where there is no need for a sealing means to prevent fluid leakage from the environment in which the sensor is positioned.

Accordingly, sensors have been developed to be configured for use with an O-ring via a groove or channel or alternatively the sensor is designed explicitly for use in a non-sealing arrangement.

### SUMMARY

An apparatus and system for providing a means for sealing a gap between a housing and a sensor inserted into an opening of the housing, the system comprises a spacer; an O-ring, the O-ring provides a sealing means between a portion of the sensor and the housing, the spacer is inserted onto a portion of the sensor prior to the O-ring; and a retaining ring, the retaining ring is inserted onto a portion of the sensor after said O-ring, the retaining ring is configured to have an interference fit with a portion of the sensor.

A method for converting a sensor designed for use in an open environment to a sensor for use in a closed environment where it is desirable to retain the fluids within the closed environment. The method comprises inserting an elongated portion of the sensor into a spacing member, the elongated portion has a first sensing means being configured to sense movement of a movable item in the closed environment; positioning an O-ring on the elongated portion adjacent to the spacer; and securing the location of the O-ring by placing a retaining member onto the elongated portion after the O-ring has been inserted thereon.

An apparatus for sealing a gap between a bore hole into which a portion of a sensor is inserted therein, comprising: a spacing member being configured to be slidably received of an elongated portion of a sensor configured to be received within a bore hole of a closed environment, the sensor having a sensing means for determining the position of an item in the closed environment, the elongated portion having a smaller diameter than the bore hole, the spacing member having an outside diameter larger than the elongated portion and less than the inside diameter of the bore hole; an O-ring being configured to be received on the elongated portion of the sensor, the O-ring being positioned on the elongated portion after the spacer is inserted thereon and the spacer positions the O-ring on the elongated portion, the O-ring having an outside diameter greater than the inside diameter of the bore hole; and a retaining ring being configured to be received on said elongated portion of said sensor, said retaining ring being positioned on the elongated portion after the O-ring is inserted thereon, the O-ring provides a sealing means between the elongated portion and the bore hole, the retaining ring having an outside diameter less than the inside diameter of the bore hole.

The above-described and other features of the present disclosure will be appreciated and understood by those skilled in the art from the following detailed description, drawings, and appended claims.

### BRIEF DESCRIPTION OF THE DRAWINGS

FIG. 1 is a top plan view of a sensor device with a sealing member constructed in accordance with an exemplary embodiment of the present invention;

FIG. 2 is a top plan view of a portion of the sealing member constructed in accordance with an exemplary embodiment of the present invention;

FIG. 3 is a view along lines 3-3 of FIG. 2;

FIG. 4 is a top plan view of a portion of the sealing member constructed in accordance with an exemplary embodiment of the present invention;

FIG. 5 is a view along lines 5-5 of FIG. 4; and

FIG. 6 is a cross sectional view of a bore hole with a sensor device inserted therein with a sealing member constructed in accordance with an exemplary embodiment of the present invention.

### DESCRIPTION OF THE PREFERRED EMBODIMENT

An apparatus and system for converting a sensor designed for use in an open environment into a sensor to be used in a closed environment (e.g. a sealed enclosure) the system includes three components each of which is easily installed on the sensor to provide a means for sealing and retaining a portion of the sensor in a bore hole or opening of the environment.

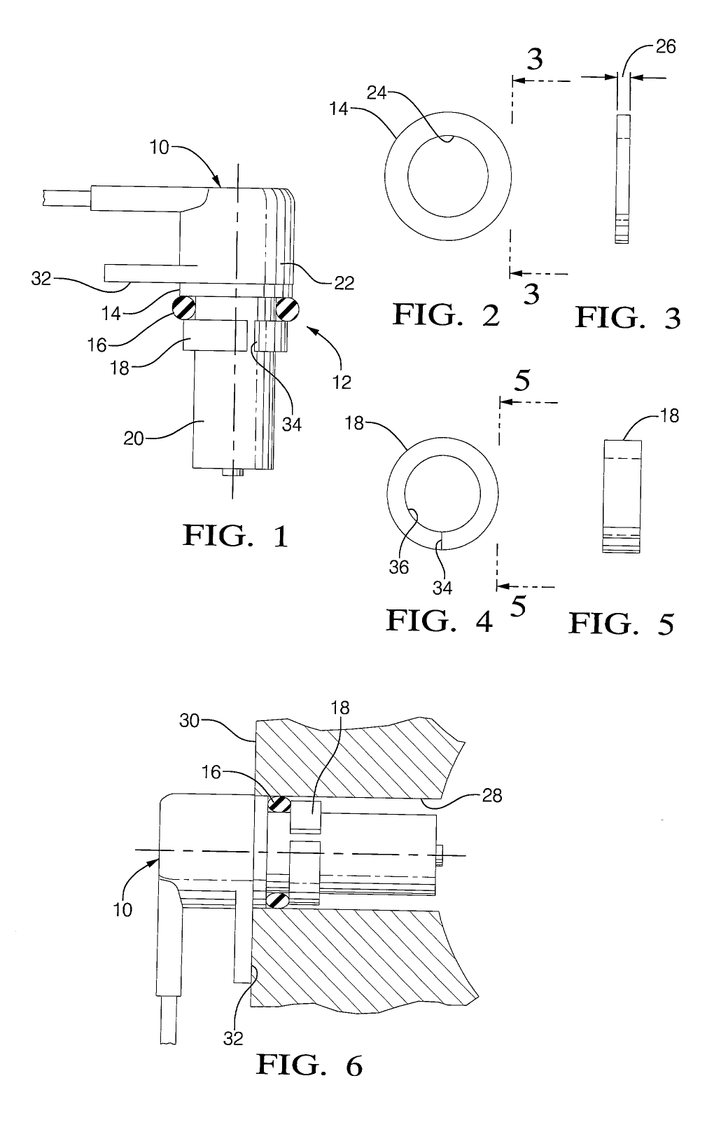

Referring now to FIG. 1, a sensor 10 having a sealing member or system 12 constructed in accordance with an exemplary embodiment is illustrated. For purposes of providing an example of a type of sensor capable of being used with sealing member 12, sensor 10 is a variable reluctance sensor. One application for sensor 10 is to sense the crank position of a crank shaft of an automobile (not shown).

Sealing member or system 12 has an inner spacing member 14, an O-ring 16 and a retaining member 18. In this embodiment sensor 10 has an elongated shaft portion 20 that depends outwardly from a main body portion 22. In this example, shaft portion 20 is circular however, as contemplated in accordance with the present invention sealing system 12 is configurable for use with sensors having other types of configurations including but not limited to squares, rectangles, and hexagons. Accordingly, inner spacing member 14, O-ring 16 and retaining member 18 would be configured to be received on the various configurations.

Referring now to FIGS. 1-6, sealing member 12 is configured for use with a sensor having circular shaft portion that is to be inserted into a circular bore hole. Inner spacing member 14 has an inner opening 24 having an inner diameter slightly larger than the outside diameter of elongated shaft portion 20. This allows spacing member 14 to be easily slid onto shaft portion 20. In accordance with an exemplary embodiment, spacing member 14 is a plastic ring whose thickness and diameter is designed depending upon the diameter and depth geometry of the bore hole into which sensor 10 is inserted. Alternatively, spacing member 14 is stamped out of a metal material of a predetermined thickness while the stamping means defines the diameter of the spacing member.

The spacing member is designed to have a thickness 26 sufficiently large enough to place or position O-ring 16 in a desirable location within a bore hole 28. Accordingly, and through the use of spacer member 14, O-ring 16 is positioned at a distance from an exterior wall or surface 30 surrounding bore hole 28. The positioning of the O-ring with respect to surface 30 locates O-ring 16 in a preferred location to retain or seal a portion of sensor 10 within bore hole 28.

During assembly, spacer ring 14 is positioned onto shaft portion 20 of sensor 10. The spacer ring 14 is positioned against a surface 32 of sensor 10. Once spacer ring 14 is in the desired position, O-ring 16 is now positioned over elongated shaft portion 20. In accordance with an exemplary embodiment, O-ring 16 is constructed out of a flexible pliable material such as rubber, which is capable of being compressed and providing a satisfactory seal between sensor 10 and bore hole 28. O-ring 16 is slid onto shaft portion 20 and is rolled into its preferred location adjacent to spacing member 14. Accordingly, the dimensions of spacer ring 14 determine the location of O-ring 16 with respect to surface 32 of the sensor.

Once O-ring 16 is positioned over elongated shaft member 20, a retaining or holding ring 18 is positioned over elongated shaft portion 20. Retaining ring 18 prevents further movement of O-ring 16 once it is in its desired location.

In accordance with an exemplary embodiment, retaining ring 18 is a plastic ring having a split 34. Retaining ring 18 includes an inner opening 36 which in this embodiment has a diameter or dimension slightly smaller than the outside diameter or dimension of shaft member 20. Accordingly, split 34 allows retaining ring to expand as it is positioned over elongated shaft portion 20.

Accordingly, and as retaining member 18 is inserted over shaft portion 20 there is an interference fit for engagement of retaining ring 18 upon the exterior surface of shaft portion 20. This is facilitated through the materials utilized to construct retaining ring 18 (e.g. a plastic or metal material capable of being expanded while retaining some resiliency). In accordance with an exemplary embodiment, retaining ring 18 is constructed out of a plastic material which is capable of being manipulated in order to provide interference fit with regard to shaft portion 20.

In summation, the three piece sealing member is inserted onto a portion of a sensor by first placing a spacing member 14 on a portion of the sensor that is to be received in a bore hole, then the O-ring is rolled onto the same portion of the sensor after the spacer ring and finally a retaining ring 18 is inserted over the shaft portion in order to provide an interference fit and fixedly position O-ring 16 in a desired location. O-ring 16 is thus maintained in its location by being disposed between spacer 14 and retaining ring 18.

It is noted that each component spacer 14, O-ring 16 and retaining ring 18 are each capable of being inserted onto sensor 10 through the use of an individual's fingers. Thus, no special tools are required for placement of sealing member 12 onto sensor 10.

Accordingly, a sensor configured for use in an open environment is quickly converted to sensor for a sensor for use in a sealed environment.

In accordance with an exemplary embodiment, it is noted that the outside diameter of the O-ring is larger than the inside diameter of the bore hole into which a portion of sensor 10 is to be inserted. In addition, O-ring 16 is configured so that approximately one-half of the O-ring depends outwardly from the outside diameter of spacer 14. Of course, spacer 14, O-ring 16 and retaining ring 18 can be configured to provide more or less surface area of O-ring 16 available to make contact with the inner diameter of the bore hole. In addition, retaining ring 18 has an even lower profile than the O-ring such that as sensor 10 is inserted into a bore hole, the first portion to make contact with the inside diameter of the bore hole is a portion of the O-ring proximate to retaining ring 18. Accordingly, and as ring 16 is depressed a portion of O-ring 16 makes contact with spacer ring 14.

In this configuration, and as O-ring 16 begins to make contact with the inner diameter of bore hole 28, O-ring 16 is manipulated into an angular configuration which will facilitate ease of insertion of sensor 10 into bore hole 28 until surface 32 makes contact with surface 30.

Accordingly, O-ring 16 is depressed in order to provide a seal between bore hole 28 and sensor 10. In addition, the outside diameter of retaining ring 14 is slightly smaller than the inner diameter of bore hole 28. This allows spacer ring 14 to travel into bore hole 28 until surface portion 32 makes contact with surface 30. In addition, and as previously mentioned, the thickness of spacer ring 14 appropriately locates O-ring 16 in a preferred sealing location.

It is noted that retaining ring 18 has an outside diameter that is slightly smaller than the outside diameter of retaining ring 14. Accordingly, retaining ring 18 is configured with a thickness sufficient enough for providing an engagement surface for preventing movement of O-ring 16. For example, during the removal of sensor 10 from the bore hole.

In addition, retaining ring 18 is configured to have an elongated cylindrical shape so as to provide a broad surface area for frictionally engaging the outside diameter of elongated shaft portion 20 of sensor 10. As an alternative, the inner surface of retaining ring 18 is provided with a knurled surface for engaging shaft portion 20. In addition, the inner surface of retaining ring 18 may also be configured to engage a threaded shaft portion 20. Thus, retaining ring 18 may threadingly engaged onto shaft portion 20.

As an alternative, it is noted that, the thickness of retaining ring 14 is capable of being varied in order to reposition O-ring 16. The repositioning of O-ring 16 may correspond to the pressure requirements of sensor 10 and/or the size of the bore hole.

In accordance with an exemplary embodiment, sealing member 12 is capable of being positioned on and used with a sensor device that it is not designed for use in a bore hole of a sealed chamber. Accordingly, sealing member 12 allows an open environment sensor to be quickly converted to a sealed chamber sensor. This system also allows the sensor to be quickly converted back to an open environment sensor.

Sealing member 12 is contemplated for use in low-pressure applications (e.g. approximately 50 psi and less). An example of these applications is an internal combustion engine or a transmission. Of course, the system of the present disclosure is contemplated for use in numerous other types of applications (e.g., housings having internal pressures greater or less than the aforementioned values).

Accordingly, variable reluctance sensors which are used for sensing crank position can be used inside or outside the engine block. When the sensor extends into the engine block (FIG. 6) an external O-ring 16 is needed to prevent an oil leak. The same sensor could be used in another application or the sensor is positioned outside the engine block in which case no sealing is required. A variable reluctance sensor is just an example of one type of sensor contemplated for use with the sealing system of the present disclosure. Other types of sensors capable of being used in both an open and closed environment are considered within the scope of the present application. Accordingly, the sealing member or system as disclosed herein is useful in that the O-ring can be included or not depending upon the application in which the sensor is used. Thus, and for particular applications only one type of sensor need to be ordered or designed as it can used with the sealing system of the present disclosure to convert its application (e.g. open or closed environment).

The sealing member as disclosed herein uses two additional components in order to complement the O-ring. A spacing plastic ring 14 whose thickness and diameter can be varied depending upon the diameter and depth of the bore hole and a split plastic holding ring 18 whose primary function would be to prevent the O-ring from rolling down from its preferred location.

Thus, if a sensor device is not designed to have an O-ring and is required to have one for use in a low pressure sealing application, the spacer ring is designed to position the O-ring appropriately and the split plastic ring is designed to prevent the O-ring from rolling down if the sensor was to be assembled and disassembled repeatedly (e.g. inserted and removed from the bore hole).

Accordingly, sealing member provides a means for securing external O-rings onto a portion of sensors that are not designed to have external O-rings. This provides a desirable design and application without having to modify the tooling required for production of the sensors.

The backup ring or spacing ring 14 is designed such that it meets the tolerances required to seal and prevent extrusion. The purpose of the retaining ring 18 is to prevent the O-ring from slipping over the same. The retaining ring will be designed such that there is an interference fit between the inner diameter of the holding ring and the sensor outer diameter, the split in the retaining ring will help with the ease of assembly. The thickness of the retaining ring will be a little larger than the backup ring in order to prevent any movement of the ring itself.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An apparatus for sealing a gap between a housing and a portion of a sensor, comprising:
a spacer being configured to be received on a portion of a sensor;
an O-ring being configured to be received on said portion of said sensor, said O-ring being positioned on said portion after said spacer is inserted thereon; and
a retaining ring being configured to be received on said portion of said sensor, said retaining ring being positioned on said portion after said O-ring is inserted thereon, said O-ring providing sealing means between said portion and an opening in a housing.

2. The apparatus as in claim 2, wherein said retaining ring is configured to have an interference fit with said portion of said sensor.

3. The apparatus as in claim 3, wherein said retaining ring is constructed out of plastic and includes a cut portion allowing said retaining ring to expand as it is inserted over said portion of said sensor.

4. The apparatus as in claim 1, wherein said portion of said sensor is an elongated cylindrical portion for insertion into a bore hole of said housing.

5. The apparatus as in claim 4, wherein said spacer has an inner diameter slightly larger than the outside diameter of said elongated cylindrical portion and said O-ring has an inner diameter slightly smaller than said outer diameter of said elongated cylindrical portion and said retaining ring has an inner diameter slightly smaller than the outside diameter of said elongated cylindrical portion.

6. The apparatus as in claim 5, wherein said retaining ring is constructed out of plastic and includes a cut portion allowing said retaining ring to expand as it is inserted over a portion of said sensor.

7. The apparatus as in claim 3, wherein said retaining ring has a lower profile with respect to said sensor than said O-ring and said spacer, said spacer having a lower profile with respect to said sensor than said O-ring.

8. The apparatus as in claim 7, wherein said spacer has an outside diameter less than the inner diameter of a bore hole into which a portion of said sensor is inserted.

9. The apparatus as in claim 3, wherein said spacer has a thickness, said thickness defining the distance said O-ring is positioned with respect to an exterior wall of an object into which said sensor is inserted.

10. The apparatus as in claim 3, wherein said retaining ring and said spacer provide a means for preventing the movement of said O-ring as said sensor is inserted and/or extracted from a bore hole.

11. The apparatus as in claim 3, wherein said retaining ring has a greater surface area for engaging a portion of said sensor.

12. The apparatus as in claim 1, wherein said sensor is a variable reluctance sensor.

13. A method for providing a sealing means for a sensor, comprising:
inserting a portion of said sensor into a spacing member;
positioning an O-ring on said sensor adjacent to said spacer; and
securing said O-ring in place by placing a retaining member onto said sensor after said O-ring has been inserted thereon.

14. The method as in claim 13, wherein said retaining member is configured to have an interference fit with said portion of said sensor.

15. A method fluidly sealing a sensor into a bore hole of an internal combustion engine, comprising:
inserting a portion of said sensor into said bore hole, said portion of said sensor having an O-ring for engaging an inner diameter of said bore hole, said O-ring being positioned on a surface portion of said sensor and said O-ring being retained in its preferred position by a spacer and a retaining member, said spacer defining a distance said O-ring is located with respect to an exterior surface of said bore hole.

16. A method for converting an open environment sensor to a closed environment sensor, comprising:
inserting an elongated portion of said sensor into a spacing member, said elongated portion having a first sensing means being configured to sense movement of a movable item;
positioning an O-ring on said elongated portion adjacent to said spacer; and
securing the location of said O-ring by placing a retaining member onto said elongated portion after said O-ring has been inserted thereon.

17. An apparatus for sealing a gap between a bore hole into which a portion of a sensor is inserted therein, comprising:
a spacing member being configured to be slidably received of an elongated portion of a sensor configured to be received within a bore hole of an engine block, said sensor having a sensing means for determining the angular position of a crank shaft within said engine block, said elongated portion having a smaller diameter than said bore hole, said spacing member having an outside diameter larger than said elongated portion and less than said bore hole;
an O-ring being configured to be received on said elongated portion of said sensor, said O-ring being positioned on said elongated portion after said spacer is inserted thereon and said spacer positioning said O-ring on said elongated portion, said O-ring having an outside diameter greater than the inside diameter of said bore hole; and
a retaining ring being configured to be received on said elongated portion of said sensor, said retaining ring being positioned on said elongated portion after said O-ring is inserted thereon, said O-ring providing a sealing means between said elongated portion and said bore hole, said retaing ring having an outside diameter less than said inside diameter of said bore hole.
